(19) United States
(12) Patent Application Publication
(10) Pub. No.: US 2007/0061428 A1
(43) Pub. Date: Mar. 15, 2007

(54) Customization of applications through deployable templates

(75) Inventors: Michael Blake Haley, San Rafael, CA (US); Joshua A. Natarajan, Tracy, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc.

(21) Appl. No.: 11/222,630

(22) Filed: Sep. 9, 2005

(51) Int. Cl. G06F 15/177

(52) U.S. Cl. 709/220

(57) ABSTRACT

A method, apparatus, and article of manufacture enable the deployment of a network collaboration service. A template package is received on a server, wherein the template package comprises one or more files and configuration data for one or more templates that each comprise functionality provided by the server for the network collaboration service. The one or more files and configuration data are converted from the template package to table data in a set of one or more tables in a database. A request is received from a client for a feature of the network collaboration service. The server then dynamically converts the table data into one or more objects (dynamically and automatically) at runtime. Thereafter, the server utilizes the one or more objects to provide the feature to the client.

### CROSS-REFERENCE TO RELATED APPLICATIONS

This application is related to the following co-pending and commonly-assigned patent application, which application is incorporated by reference herein:

U.S. patent application Ser. No. 09/539,500, entitled “METHOD AND APPARATUS FOR PROVIDING ACCESS TO DRAWING INFORMATION”, by Brian P. Mathews, et. al., Attorney Docket No. 30566.80-US-U1, filed on Mar. 30, 2000, which application claims the benefit of U.S. Provisional Application Ser. No. 60/132,057, entitled “AUTOMATED SEARCHING AND DISTRIBUTION OF DESIGN DRAWING DATA TO INTERNET BROWSERS,” filed on Apr. 30, 1999, by Brian Phillip Mathews et. al., Attorney's Docket Number 30566.80-US-P1.

U.S. patent application Ser. No. 09/534,757, entitled “METHOD AND APPARATUS FOR DRAWING COLLABORATION ON A NETWORK”, by Mark E. Sweat, et. al., Attorney Docket No. 30566.79-US-U1, filed on Mar. 24, 2000, which application claims priority to United States Provisional Patent Application Ser. No. 60/126,170, entitled “CAD DRAWING COLLABORATION VIA WEB BASED SYSTEMS”, by Mark E. Sweat et. al., Attorney Docket No. 30566.79-US-P1, filed on Mar. 25, 1999.

### BACKGROUND OF THE INVENTION

1. Field of the Invention

The present invention relates generally to Internet/web-based applications, and in particular, to a method, apparatus, and article of manufacture for customizing an application through deployable templates.

2. Description of the Related Art

In the architectural, engineering, and construction (AEC) industry, persons that collaborate on a project (e.g., architects, designers, engineers, contractors, etc.) are often in geographically diverse locations. Online project collaboration services, (e.g., Buzzsaw™ available from the assignee of the present invention) may be utilized to allow the individuals/entities of a project to collaborate with each other in an efficient manner. Such project collaboration services allow the proactive management of projects and the optimization of performance at each stage in a project lifecycle.

However, different projects and customers often have different approaches and requirements. Accordingly, when launching a collaboration service, the service provider is often forced to customize the service to meet the exact demands of a customer. Such customization may be simple (such as the layout of a form) to complex (such as modified business logic, data definitions, and user interfaces). A complex and complete customization typically requires complex code changes and careful management of different source code bases for different clients (i.e., several customized applications execute on a server in parallel for the different clients). In addition, the geographic distribution of project collaborators may result in collaborators that speak different languages. Thus, the service provider may need to display multiple different web pages in different languages to different collaborators on the same project (thereby requiring additional customization). These problems may be better understood with a description of prior art collaboration services and customization.

As described above, the procedures utilized in a project may vary from company to company. For example, the layout of a form used in a request for information (RFI) that is sent by a manager to various personnel (e.g., engineers, subcontractors, etc.) may differ from company to company. In this regard, each company has a different logo, questions, fields, etc. In another example, the submittal process throughout a project's life cycle may change. Drawings may be submitted and pass through a series of approval steps (e.g., drawings based on blueprints may pass to engineers, architects, project managers, etc.). However, each company/project may have a different path for approval of such drawings. Further, each company/project may have different categories of documents and different storage locations. Also, based on various differences, the business logic for managing the different personnel and documents may change from project to project or company to company.

In view of the above, what is needed is a system wherein customization may be performed in an efficient and easily managed manner. In this regard, what is needed is the ability to provide multiple simultaneous customizations of specific base functionality(ies) on a server without changing any core architectural components of the server. Furthermore, customizations should be flexible allowing deployment at runtime and be targeted at only specific customers. In addition, the customizations need to readily support multiple languages from the same customization (for collaboration between different language clients) and customizations should also ensure the ultimate integrity of the customized solution (i.e., keeping all of the separately customized aspects together).

### SUMMARY OF THE INVENTION

To overcome the difficulties of the prior art, the invention provides an online collaboration system consisting of various templates that may be deployed and used at runtime in an efficient manner. Various different features and functionality of an online service are selected (e.g., by or through interaction with a user). The selected features may be customized features or standard features. The selected features relate to different types of information such as the user interface, workflow, etc. Each of the different types of information may be categorized into templates. Accordingly, the selection of features corresponds to the selection of various different templates that together make up a user site of an online collaboration service.

The different types of templates may be used and referenced by the online collaboration system. In this regard, an application template identifies a particular application as an aggregation of ancillary templates. A user interface template defines hypertext markup language (HTML) pages and application programming interface (API) calls that constitute a surface of a typical application. A form template defines a data form used to supply data to the online collaboration service. An entity template defines basic data objects and an entire domain data model for the online collaboration service. A workflow template describes business logic of the online collaboration service as a scripted workflow. A dashboard template defines a report against the online collaboration service. An email template defines a layout and contents of an automated email sent to a client as part of the online collaboration service's workflow.

Each of the different templates may be represented by one or more files and configuration data that describes the template. The configuration data may be in the form of an extensible language (XML) manifest file and the accompanying files are the files related to/needed by the template or XML manifest file. In this regard, the configuration data for one of the templates comprises a manifest file (e.g., an XML manifest file) that comprises an identification of one or more additional related templates and a type of a relationship between the template and additional template. Further, the invention also provides the ability to publicly expose (or only permit access to internal application logic) certain templates (or aspects of the templates).

The different files and configuration data for the various templates are packaged together into a template package. Such a template package may be compressed (e.g., into a zip file).

Once the template package is pushed onto a server that hosts the online collaboration service, the server converts the one or more files and configuration data from the template package to table data in a set of one or more tables in a database. The server/application server receives a request from a client for a feature of the network collaboration service. Upon receiving the request, the system simply dynamically converts the table data into one or more objects at runtime and utilizes the one or more objects to provide the feature to the client.

Since the objects are created dynamically at runtime, different cultures, web browsers, or other “aspects” may be used to view the same client information. For example, the server may dynamically determine a language of the client based on the request from the client. Thereafter, when the table data is dynamically converted into objects, a template name is retrieved from the set of one or more tables, feature data for the feature based on the template name and language is retrieved, and the language-specific data is then instantiated into the appropriate objects. Thus, the data maybe customized for a client collaboration site for various users of the site based on the user's language/culture, web browser version, etc.

In addition, based on the structure of the templates, set of data tables, and object conversion, if a template or element of the template were to change or be updated, the updated template can easily be converted into the appropriate tables used to create/instantiate the objects without restarting the server software.

### BRIEF DESCRIPTION OF THE DRAWINGS

Referring now to the drawings in which like reference numbers represent corresponding parts throughout:

FIG. 1 schematically illustrates a hardware and software environment in accordance with one or more embodiments of the invention;

FIG. 2 illustrates a sample template package with referenced files and a manifest in accordance with one or more embodiments of the invention;

FIG. 3 illustrates an SQL schema for tables that are created based on the XML manifests in accordance with one or more embodiments of the invention;

FIG. 4 depicts the interactions of APIs from both an internal and public viewpoint in accordance with one or more embodiments of the invention;

FIG. 5 illustrates a unified modeling language (UML) diagram depicting the object model for access to templates in accordance with one or more embodiments of the invention; and

FIG. 6 illustrates the logical flow for creating and using templates in accordance with one or more embodiments of the invention

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Hardware Environment

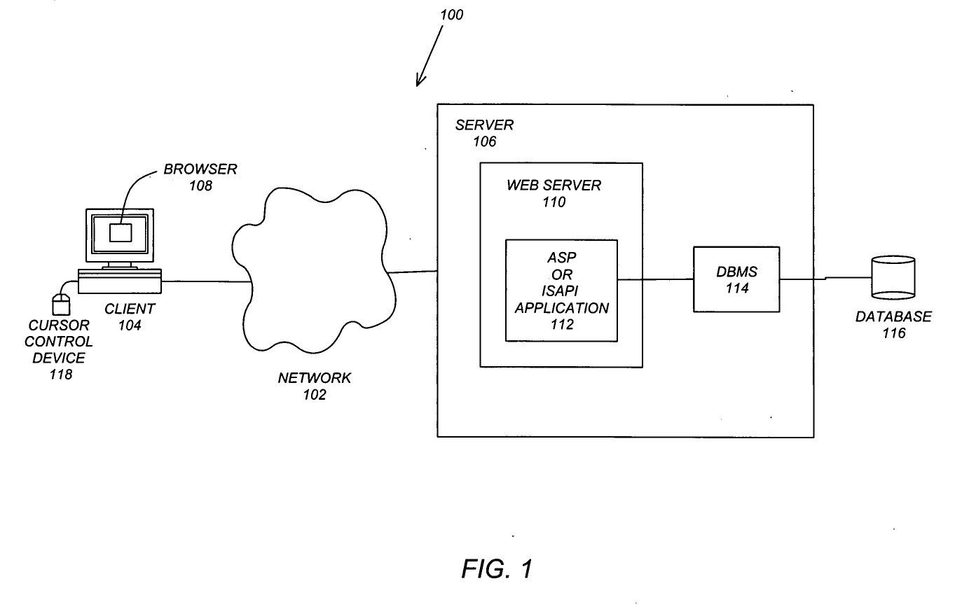

FIG. 1 schematically illustrates a hardware and software environment in accordance with one or more embodiments of the invention, and more particularly, illustrates a typical distributed computer system 100 using a network 102 to connect client computers 104 to server computers 106. A typical combination of resources may include a network 102 comprising the Internet, LANs, WANs, SNA networks, or the like, clients 104 that are personal computers or workstations, and servers 106 that are personal computers, workstations, minicomputers, or mainframes. Additionally, both client 104 and server 106 may receive input (e.g., cursor location input) and display a cursor in response to an input device such as cursor control device 118.

A network 102 such as the Internet connects clients 104 to server computers 106. Additionally, network 102 may utilize radio frequency (RF) to connect and provide the communication between clients 104 and servers 106. Clients 104 may execute a client application or Web browser 108 and communicate with server computers 106 executing Web servers 110. Such a Web browser 108 is typically a program such as NETSCAPE NAVIGATOR™ or MICROSOFT INTERNET EXPLORER™. Further, the software executing on clients 104 may be downloaded from server computer 106 to client computers 104 and installed as a plug in or ActiveX control of a Web browser. Accordingly, clients 104 may utilize ActiveX components/component object model (COM) or distributed COM (DCOM) components to provide a user interface on a display of client 104. The Web server 110 is typically a program such as Microsoft's Internet Information Server.

Web server 110 may host an Active Server Page (ASP) or Internet Server Application Programming Interface (ISAPD application 112, which may be executing scripts. The scripts invoke objects that execute business logic (referred to as business objects). The business objects then manipulate data in database 116 through a database management system (DBMS) 114. Alternatively, database 116 may be part of or connected directly to client 104 instead of communicating/obtaining the information from database 116 across network 102. When a developer encapsulates the business functionality into objects, the system may be referred to as a component object model (COM) system. Accordingly, the scripts executing on web server 110 (and/or application 112) invoke COM objects that implement the business logic. Further, server 106 may utilize Microsoft's Transaction Server (MTS) to access required data stored in database 116 via an interface such as ADO (Active Data Objects), OLE DB (Object Linking and Embedding DataBase), or ODBC (Open DataBase Connectivity).

Generally, these components 108-118 all comprise logic and/or data that is embodied in or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Thus, embodiments of the invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass logic and/or data accessible from any computer-readable device, carrier, or media. Further, the system may be implemented in an object oriented programming system with objects having methods and or data.

Those skilled in the art will recognize many modifications that may be made to this exemplary environment without departing from the scope of the present invention. For example, those skilled in the art will recognize that any combination of the above components, or any number of different components, including different logic, data, different peripherals, and different devices, may be used to implement the present invention, so long as similar functions are performed thereby.

ProjectPoint™

Software (referred to as ProjectPoint™) provides for the unique organization of folders as containers for storing, managing, and sharing files and discussions for an architectural project. The ProjectPoint™ software may be downloaded and installed on a computer. Further, ProjectPoint™ may work in combination with or independently from a user's internet browser such as the Internet Explorer available from Microsoft™. Once installed, a user may initialize the ProjectPoint™ software by starting the ProjectPoint™ application or by attempting to access a web site (or an area of a website) that is configured to work with ProjectPoint™ (at which point, the ProjectPoint™ application will automatically initialize on the user's browser 108). Once the software is initialized, the user is prompted to log in using a user name and password (see description below). Upon successful login, information is downloaded from the website/server 106 to the local computer 104 and displayed in accordance with the ProjectPoint™ software. Thus, ProjectPoint™ may be viewed as an application and as a web site and applet with a series of pages and programming modules utilized by a web server 110 and web browser 108.

In accordance with one or more embodiments of the invention, ProjectPoint™ is an online service for building design and construction teams that provides an integrated “project” workspace.” ProjectPoint™ centralizes the management of project drawings, documents, and communications on a project website. Further, ProjectPoint™ provides relevant content, services, and software tools to help team members complete tasks.

In accordance with one or more embodiments of the invention, the ProjectPoint™ line service may be customized for a particular client's site. As described above, such customization may range from the user interface to the business logic, to the data definitions.

Template System

To provide flexible and efficient customization capabilities, the invention provides a modular system consisting of various templates specialized to various areas of customization. In addition, a template facility consists of the core functionality for managing and defining the templates. Accordingly, various templates may be defined for different customizable areas of the online collaboration system. The various selected templates may then be packaged together into an application template package and deployed for a particular client.

The template system overcomes many problems of the prior art and satisfies numerous requirements. In this regard, the templates are dynamically deployable at run-time. A template (and all of its contained files and settings) act (and are deployed) as a single entity. Every template is uniquely addressable and is able to contain arbitrary files required by a particular application. The contents of a template (both files and configuration aspects) support multiple variations dependent upon external runtime factors such as client language/region, browser version, screen resolution, etc. Since an end-user application may consist of multiple templates and specific templates may be shared between different applications, the dependencies between templates and the dependencies between applications and templates are represented and managed. Further, some aspects of the templates are public content directly accessible by external clients (e.g., button icon images) and other aspects are only accessible to internal application logic (e.g., workflow scripts).

Template Package

The template system utilizes a “template package” as the pre-deployment entity/representation (file-format) that contains all of the files and configuration related to the actual template. Accordingly, the template package completely contains a compressed archive of all of the associated/related files of a template (e.g., image, scripts, layouts, schemas, etc.) as well as an XML (extensible markup language) manifest file that defines the template itself. The XML manifest file describes the contents of the template, the access to the template, as well as all of the other parameters of the template (e.g., references, configurations, etc.). In this regard, the XML manifest file defines the template identity (uniquely)(e.g., a unique identifier or globally unique identifier [GUID]) and the configuration of the template and addressing for all of the content files contained within the package as it relates back to the configuration.

Each template package is a zip file and contains a single XML manifest file and all of the relevant files that the template requires. However, multiple template packages/zip files can be combined into a larger template package or zip file thereby providing hierarchical packaging capabilities. Further, if a template package requires other templates that are only relevant to the particular template package (e.g., a form template that is only specific to a particular workflow template), then the package file/zip file for the dependent template may be recursively contained within the parent zip file. The template package is identified by the unique GUID that is contained at the top of the manifest file.

Specific files may also be “keyed” to have multiple variations. When retrieving a file, a different file (or a different version of a particular file) may be returned based on the key and the properties of the current web server request such as: culture (language/region settings of the client), web-browser version, and any other property determinable through the current web server request. Such localization processing and multi-browser support is thereby transparent to the user and programmer.

Several different types of templates may be defined (the type of template may be expressed within the configuration section of the template) to represent some or all of the aspects of a web based collaboration application.

An application template identifies a particular application as an aggregation of ancillary templates. Typically, this template has no content itself but rather acts as the root template of an application. Accordingly, the application template may be viewed as a template that contains the grouping of all of the other templates needed for a particular application.

A user interface (UI) template defines the HTML pages and application programming interface (API) calls that constitute the surface of a typical application.

A form template defines the data forms used to supply data to the application including validation and layout of the data.

An entity template defines the basic data objects and entire domain data model for an application.

A workflow template describes the business-logic of the application as scripted workflows based on states, activities, and participants.

A dashboard/report template defines reports against the application and workflow data for the application.

An email template defines the layout and contents of automated emails sent to clients as part of the application's workflow.

The result of the functionality provided by the various templates is a completely defined application where all aspects of the application can be dynamically deployed to servers (i.e., that host the collaboration service) without software restarts. Additionally, the runtime template management logic constantly monitors the templates database for any changes. When an update is detected, the previous templates are unloaded and the new templates are loaded and surfaced to the relevant users.

Extension of any application may be easily accomplished through manipulation of any of the templates constituting an application specific to particular users. Furthermore, the customizations can be dynamically deployed to the user when available.

Manifest File

The XML manifest file has a fixed schema and may include one or more of the following sections:

(1) a document tag (template) that specifies: the GUID of the template, an internal name for the template (not necessarily unique), and the type of the template.

(2) <label>: a set of tags that contain the user-surface-able label for this template in various cultures;

(3) <contents>: a single tag containing multiple <file>sections that identify each of the files that the template package contains. For each file the access (public/internal) is specified as well as the various “aspects” (see below) of the file corresponding to multiple cultures.

(4) <references>: a set of tags that identify the templates (by GUID) that are related to the current template. For each template, the nature of the relationship is specified (e.g., Universal, Related, dependent, sibling, parent, etc.) as well as whether the referenced template zip-file is actually contained within the current zip-file or whether it is pushed separately. Each template reference defines an alias that is used throughout the rest of the manifest to refer to the referenced template. The example below illustrates a references section in accordance with one or more embodiments of the invention:

```
<references>
  <template alias=“form” id=“CDE8C6E4-32EB-4796-91BF-
    573A7F4DC59C” relationship=“universal” />
  <template alias=“formlogdashboard” id=“7E8CF430-
    7281-430d-82D4-518ED88C580E”
    relationship=“universal” />
  <template alias=“detailreport” id=“80dfaa46-8e48-
    11d8-b1aa-505054503030”
    relationship=“universal” />
  <template alias=“listreport” id=“F507D422-91AF-
    4709-A41A-0319345CC914”
    relationship=“universal” />
  <template alias=“email” id=“A0475026-C58f-45A9-
    9A6B-63dECC3DFA28” relationship=“universal”
    />
</references>
```

(5) <config>: a set of custom tags that specify the configuration of the object that the template represents. The XML within these tags is dependent on the type of the template and is separately defined. The various elements within the configuration may reference the other files within the template in which case they need to relate to the files expressed within the <contents> section described above. There is no need for the template-specific configuration to describe multiple language files because this is handled by the <contents> tags. See the description below of the “Configurations” section for details regarding the contents of the <config> tags for various specific types of templates.

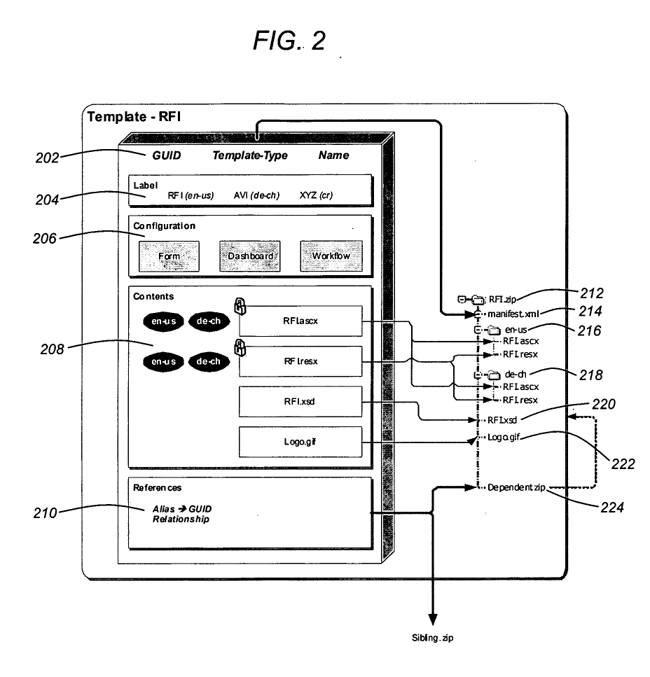

FIG. 2 illustrates a sample package with its referenced files and manifest. The template package of FIG. 2 is an RFI (Request for Information template). The template has a document tag 202 across the top containing the GUID, template type, and name. Below the document tag 202 is the label tag 204 that contains the labels for the template in various cultures/languages. The configuration section 206 contains the details regarding the configuration of the objects that the template represents. The contents section 208 specifies the contents of the template package for the various cultures/languages and whether each file is publicly accessible or internal to the program (e.g., internal files are identified using an icon of a lock). The references section 210 identifies all of the templates related to the RFI template and the type of relationship of each listed template.

The right side of FIG. 2 identifies a hierarchical listing of each file and how it corresponds to the different sections identified on the left side of the figure. Accordingly, the RFI package is a zip file 212 that has the manifest.xml file 214 and other accompanying files 216-224. As illustrated, the other accompanying files consist of the RFI.ascx and RFI.resx files in both en-us 216 and de-ch 218 cultures, the RFI.xsd file (i.e., XML schema file) 220, a logo 222 and a related template referred to as dependent.zip 224. The references section 210 also contains a reference to another template sibling.zip that is not dependent on the RFI.zip package and is therefore not part of the contents of the package.

Aspects

As described above, data contained within a manifest may have multiple versions for different languages, regions, web-browser capabilities, etc. The different versions of data are referred to as “aspects”. Data has multiple aspects when there are multiple versions of the same content but that differ by language, region, browser-version, or some other external variable. There are two types of data contained within the manifest that may have “aspects”. The two types of data are: textual labels and files. The manifest file may handle variations on this content dependent on culture or other variable.

Labels—wherever a textual label is specified (something that is ultimately surfaced to a user of the system), it may need to be specified in multiple languages if the template itself is to serve multiple languages. The XML syntax for describing this is as follows:
<label culture=“{culture-string}”>{culture-specific-label-contents}</label>
where {culture-string} is a standard culture string such as “en-us”. Multiple <label> tags may then be specified for the various supported cultures.

Files—whenever files are specified in a template package there may be multiple versions of a given file specific to different cultures. The multiple files may be placed within different subdirectories within the ZIP file or may have different file names as illustrated in FIG. 2. The manifest file then provides a “unifying” filename that is mapped to one of the specific files within the ZIP file based on a culture string. The XML syntax for describing this is as follows:
<file name=“{unified-filename}” aspects=“true”...>
<aspect culture=“{culture-string}” path=”{real-file-path}”/>
</file>
where {culture-string} is a standard culture string such as “en-us”. Multiple <aspect> tags may then be specified for the various supported cultures.

The following portion is an example of how an XML manifest file will designate the various cultures in accordance with one or more embodiments of the invention:

<label culture=“en”>Gatekeeper</label>
<label culture=“de”>Koordinator</label>
<label culture=“fr”>Opérateur de contrôle</label>
<label culture=“es”>Coordinador</label>
<label culture=“ja”> [symbol] </label>
<label culture=“ko”> [symbol] </label>
<label culture=“zh-CN”> [symbol] </label>

As can be seen in the example, various cultures/languages may be supported such as English, German, French, Spanish, Japanese, Korean, and Chinese.

Configurations

The various template types may specify specific configurations with the <config> tag. The following is a brief description of the custom tags that may be specified for each template type.

Dashboard/Report Template

The dashboard/report configuration specifies numerous “panels”. Each panel describes a specific atomic dashboard/report that contains a particular set of data and that is managed in a particular way. For each panel there is a <panel> tag that specifies a name for the panel as well as the CLR class that may be used to render and manage the panel on the server.

The <panel> tag may contain a single type-specific tag that both specifies the type of the panel as well as the parameters of the panel. The tags (and types) are:
<layout> . . . describes the layout of a dashboard that consists of other dashboard panels. (i.e. this is a composite container.)
<table> . . . a table of data with: the underlying query, the columns (data mappings) and the headers identified. The <query> tag used to define the query specifies a SQL query with any number of optional input parameters and an XML Schema that defines the format of the results. A dashboard that instantiates this panel is then responsible for supplying these parameters to this panel.
<report> . . . identifies a report over some data described by a particular layout (e.g., a Crystal Report™ layout). Additionally the query behind the report is specified. The <query> tag used to define the query specifies a SQL query with any number of optional input parameters and an XML Schema that defines the format of the results. A dashboard that instantiates this panel is then responsible for supplying these parameters to this panel.
<chart> . . . describes a graphical chart over a particular data query. The chart is described by an Infragistics NetAdvantage layout file (XML).
Additionally the query behind the chart is specified. The <query> tag used to define the query specifies a SQL query with any number of optional input parameters and an XML Schema that defines the format of the results. A dashboard that instantiates this panel is then responsible for supplying these parameters to this panel.
<content> . . . pulls content from the site in which the dashboard is running based on a set of parameters. The content (e.g. an image or an HTML file) is then displayed within the panel.
   Form Template

Form configuration describes a data schema and then any number of “chapters” that are different representations of a form against the data set. Each chapter may specify a different format of form. Each format needs to have a file contained within the template that describes it. The supported formats could be:
ASCX—An ASP.NET Web Form.
XSLT—A read-only representation of the form data.
XSN—An InfoPath™ form.
XDP—An Adobe™ Form template.
SPS—An Altova™ forms layout.

Additionally each chapter may specify a RESX file also contained within the template for multi-language content. The example below illustrates a form template in accordance with one or more embodiments of the invention:

```
<?xml version=“1.0” encoding=“utf-8” ?>
<template xmlns=“urn:schemas-autodesk-
    com:buzzsaw:templates” id=“CDE8C6E4-32EB-4796-91BF-
    573A7F4DC59C” name=“RFI” type=“form”>
  <label culture=“en”>RFI</label>
  <label culture=“de”>RFI</label>
  <label culture=“fr”>DI</label>
  <label culture=“es”>SDI</label>
<group name=“RFI”>
  <label culture=“en”>RFI</label>
  <label culture=“de”>RFI</label>
  <label culture=“fr”>DI</label>
  <label culture=“es”>SDI</label>
</group>
<config xmlns:B=“urn:schemas-autodesk-
    com:buzzsaw:templates:form”
    xmlns:xsd=“http://www.w3.org/2001/XMLSchema”>
  <B:form schema=“RFI.xsd” default=“default.xml”>
    <B:chapters default=“view”>
    <B:chapter name=“edit” type=“aspx” format=“RFI-
      Edit.ascx” />
    <B:chapter name=“respond” type=“aspx” format=“RFI-
      RespondEdit.ascx” />
    <B:chapter name=“creator_edit” type=“aspx”
      format=“RFI-CreatorEdit.ascx” />
    <B:chapter name=“response_edit” type=“aspx”
      format=“RFI-ResponseEdit.ascx” />
    <B:chapter name=“view” type=“xslt” format=“RFI-
      View.xsl” />
    </B:chapters>
  </B:form>
</config>
<contents>
  <file name=“RFI-Edit.ascx” scope=“internal”>
    <aspect culture=“en” path=“en/RFI-Edit.ascx” />
    <aspect culture=“de” path=“de/RFI-Edit.ascx” />
    <aspect culture=“fr” path=“fr/RFI-Edit.ascx” />
    <aspect culture=“es” path=“es/RFI-Edit.ascx” />
  </file>
  <file name=“RFI-CreatorEdit.ascx” scope=“internal”>
    <aspect culture=“en” path=“en/RFI-CreatorEdit.ascx”
      />
    <aspect culture=“de” path=“de/RFI-CreatorEdit.ascx”
      />
    <aspect culture=“fr” path=“fr/RFI-CreatorEdit.ascx”
      />
    <aspect culture=“es” path=“es/RFI-CreatorEdit.ascx”
      />
  </file>
  <file name=“RFI-ResponseEdit.ascx” scope=“internal”>
    <aspect culture=“en” path=“en/RFI-
      ResponseEdit.ascx” />
    <aspect culture=“de” path=“de/RFI-
      ResponseEdit.ascx” />
    <aspect culture=“fr” path=“fr/RFI-
      ResponseEdit.ascx” />
  <aspect culture=“es” path=“es/RFI-
  ResponseEdit.ascx” />
    </file>
      <file name=“RFI-RespondEdit.ascx” scope=“internal”>
    <aspect culture=“en” path=“en/RFI-RespondEdit.ascx”
      />
    <aspect culture=“de” path=“de/RFI-RespondEdit.ascx”
      />
    <aspect culture=“fr” path=“fr/RFI-RespondEdit.ascx”
      />
    <aspect culture=“es” path=“es/RFI-RespondEdit.ascx”
      />
  </file>
  <file name=“RFI-View.xsl” scope=“internal”>
    <aspect culture=“en” path=“en/RFI-View.xsl” />
    <aspect culture=“de” path=“de/RFI-View.xsl” />
    <aspect culture=“fr” path=“fr/RFI-view.xsl” />
    <aspect culture=“es” path=“es/RFI-View.xsl” />
  </file>
  <file name=“default.xml” scope=“internal”>
    <aspect culture=“en” path=“en/default.xml” />
    <aspect culture=“de” path=“de/default.xml” />
    <aspect culture=“fr” path=“fr/default.xml” />
    <aspect culture=“es” path=“es/default.xml” />
  </file>
  <file name=“RFI.xsd” scope=“public” path=“RFI.xsd” />
</contents>
<references />
</template>
```

As can be seen from the example, numerous cultures/languages/aspects are supported. Each of the different sections of the template has different filenames or locales depending on the aspect. For example, the same file name “RFI-Edit.ascx” remains the same for each aspect but the folder in which the file is located changes depending on the aspect. Accordingly, the system will retrieve the appropriate file from the appropriate location depending on the aspect utilized. The form has various chapters/sections that provide different portions of the form.

Workflow Template

The workflow configuration describes the workflow process itself. It identifies the inputs of the workflow, the actions that can be executed against it, and the various configurations of the workflow.

There are four different sections of tags within the workflow configuration as follows:
<actions> . . . describes the user interactions that may trigger events into the workflow process. For each action: the label of the action is defined (using culture aspects again); the restrictions as to who can incur the action (described in terms of participants . . . see below); visual information such as the form and/or dashboard to use; as well as how the data will be routed and what parameters are available for routing.
<participants> . . . a list of logical “participants” that identify the various types of participants in the workflow at each logical stage. Each participant type has a label defined (aspects again) and whether it may be specified in terms of roles, users, and/or user-groups.
<configuration> . . . a list of typed parameters that the workflow can take as its basic input for configuration. Each parameter is described in terms of an XSD type and a label (aspected).
<services> . . . identifies the WSDL files that specify the inputs of the workflow process (BPEL4WS script) and describes each interface. Each interface (operation and port-type) specifies an alias that can be used through the configuration (e.g. in the <actions> section) for linking to a particular WS interface. Additionally, the logging of each interface may be specified.
   Email Template

Email configuration is similar to forms in that it describes a schema and a set of chapters where each chapter defines a layout of an email. All email layouts are expressed in terms of an XSL transform file that needs to be within the same template. For each chapter the resulting format (from the XSL transform) needs to be identified.

Audit Log Template

The configuration of an audit-log template involves mapping various named interface actions (e.g. from a web-service) and its associated XML to a formatted, visually acceptable, layout. Each layout is described in terms of an XSL transform that runs against the XML that describes a particular audit-log entry.

Entity Template

The entity template defines the basic data objects and entire domain data model for the application. The contents of such a template may merely reference a filename, the file's location, and whether the file is public or private. The configuration for an entity template specifies the different class names and elements within the class. The example below illustrates a sample entity template in accordance with one or more embodiments of the invention:

```
<?xml version=“1.0” encoding=“utf-8” ?>
<template xmlns=“urn:schemas-autodesk-
      com:buzzsaw:templates” id=“A8F8DFB8-D93A-4436-9B32-
      FC5086267AA7” name=“SubmittalItem” type=“entity”>
<label culture=“en-us”>Submittal Item</label>
<group name=“DataModel”>
  <label culture=“en-us”>Submittals Data Model</label>
</group>
<config xmlns:B=“urn:schemas-autodesk-
      com:buzzsaw:templates:entity”>
  <B:entity schema=“SubmittalItem.xsd”>
  <B:schema namespace=“urn:schemas-autodesk-
      com:entity:submittal”
      codenamespace=“Autodesk.Buzzsaw.DataModel.Entities.
      Submittals”>
    <B:class name=“SubmittalItem”
      type=“SubmittalItemType” table=“EnSubmittalItem”>
      <B:element name=“name” column=“cName”
        type=“sql:nvarchar” length=“80” />
      <B:element name=“number” column=“nNumber”
        type=“sql:int” />
      <B:element name=“display_number”
        column=“cDisplayNum” type=“sql:nvarchar”
        length=“20” />
      <B:element name=“description” column=“cDescription”
        type=“sql:nvarchar” length=“256” />
      <B:element name=“item_type” column=“cItemType”
        type=“sql:nvarchar” length=“50” />
      <B:element name=“other” column=“cOther”
        type=“sql:nvarchar” length=“20” />
      <B:element name=“quantity” column=“nQuantity”
        type=“sql:int” />
      <B:element name=“status” column=“cStatus”
        type=“sql:nvarchar” length=“50” />
      <B:element name=“idCreator” column=“nCreatorID”
        type=“id:user” />
      <B:element name=“log” column=“nLogEntityID”
        type=“id:entity”>
        <B:references refid=“0D32960C-F79F-4257-B46C-
        DD044294B30E” />
      </B:element>
      <B:element name=“package” column=“nPackageID”
        type=“id:entity”>
        <B:references refid=“71A3FF58-B951-4889-84F7-
        CAEE7ADB439F” />
      </B:element>
      <B:element name=“attachment”>
      <B:element name=“idActiveAttachment”
        column=“nActiveAttachmentID”
        type=“id:resource” />
      <B:element name=“idAttachment”
        column=“nAttachmentID” type=“id:resource” />
      <B:element name=“attachment_version”
        column=“nAttachmentVer” type=“sql:int” />
      </B:element>
    </B:class>
  </B:schema>
  </B:entity>
  </config>
  <contents>
      <file name=“SubmittalItem.xsd” scope=“public”
  path=“SubmittalItem.xsd” />
  </contents>
  <references />
  </template>
```

Database Schema

As described above, the template package consists of a zip file containing all of the elements necessary for customization for a particular client. The next issue that arises is how to use the template package. Once the template package is forwarded to a server, the package is unzipped and dynamically converted into a database. In this regard, the manifest is parsed and rows are added to a set of database tables that supply the template information at runtime. A series of application programming interfaces (APIs) may be used to retrieve files and configuration information using an object-model specific to the data within the templates.

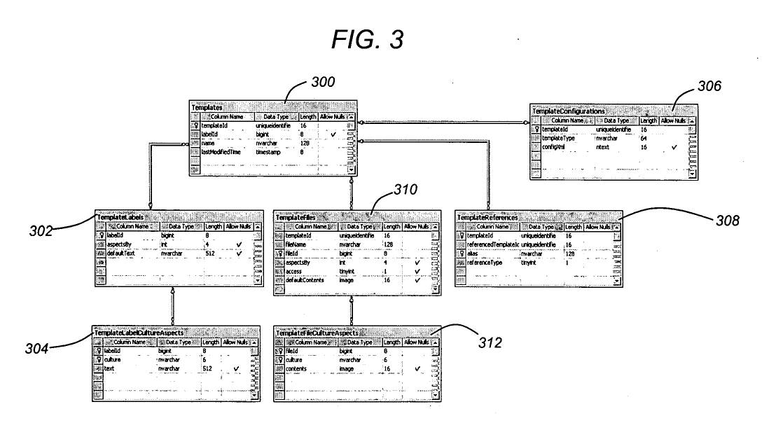

FIG. 3 illustrates an SQL schema for tables that are created based on the XML manifests in accordance with one or more embodiments of the invention. The configuration-specific portions of each template are represented as XML thereby allowing a flexible description of the template. At runtime, the XML documents are parsed into the relevant objects. The different tables illustrated in FIG. 3 list the columns/fields and type of information for each column/field.

Table 300 is the template table that provides a list of each of the templates based on a template identification, a label identification, a name of the template, and the time that the template was pushed onto the server/modified. Note that the label identification provides the name of the template in the different aspects. Table 302 provides a collection of template names (e.g., in the different aspects) for the template and the type of aspect (e.g., language, browser, etc.). In this regard, the labelID provides the name of the template and the different aspects that the template exists in. Table 304 is particular to the culture aspect and provides a list of the file names (i.e., label ID) in each culture. Different tables similar to table 304 would exist if different aspects were established (e.g., TemplateLabelBrowserAspects).

Table 306 corresponds to the configuration section from the manifest XML document described above. Accordingly, the table 306 provides a template ID that corresponds to the template table 300 followed by the type of template (e.g., entity, form, etc.) and the actual XML text from the manifest file (i.e., configXml).

Table 308 corresponds to the references section of the XML manifest file. As described above, the table has a template ID, a ID for the referenced template, an alias for the name of the referenced template, and the type of reference (i.e., whether the template is used outside of this template or only within the template). The reference type may be used to determine whether to delete a particular template.

Table 310 corresponds to the content section of the XML manifest document. Thus, each row has the template ID, a filename, an ID for the file, an identification of the type of aspect (e.g., language, browser, etc.), and default contents if the contents are not provided in table 312. Table 312 provides an entry/row for each file in each culture. In other words, for each fileID listed in table 310, there are multiple entries in table 312 that reflects the different cultures (e.g., a different row would exist for each culture: en, de, fr, es, ja, etc.). Accordingly, each row in table 312 has a file ID, the culture for the file, and the contents of the particular culture based file/content.

In accordance with the schemas illustrated, the template package is converted into the various database tables upon arrival at the server. At runtime, the tables are used to dynamically create the objects that are used to view and manipulate the various files needed. Once the objects are created/instantiated for the first time, other clients that utilize the template merely use the existing objects without having to recreate or instantiate new objects (unless the tables have changed since the objects were created).

API and Object Model

Application Programming Interfaces (APIs) may be used to access the templates and object-model that represents them. The contents of a template may need to be accessed internally (i.e. from an internal software component) or externally (e.g. from a browser as an “href”). The individual files that constitute the template's contents need to be identified as being externally available. Each template has a unique identifier, so that together with a file-name (and perhaps—path) each file may be retrieved either through an internal API or an external (public) URL.

The internal APIs to access templates are provided by two static singleton classes:
TemplateAccess—For retrieving template files and configuration;
TemplateManagement—For enumerating existing templates and adding/removing template packages.

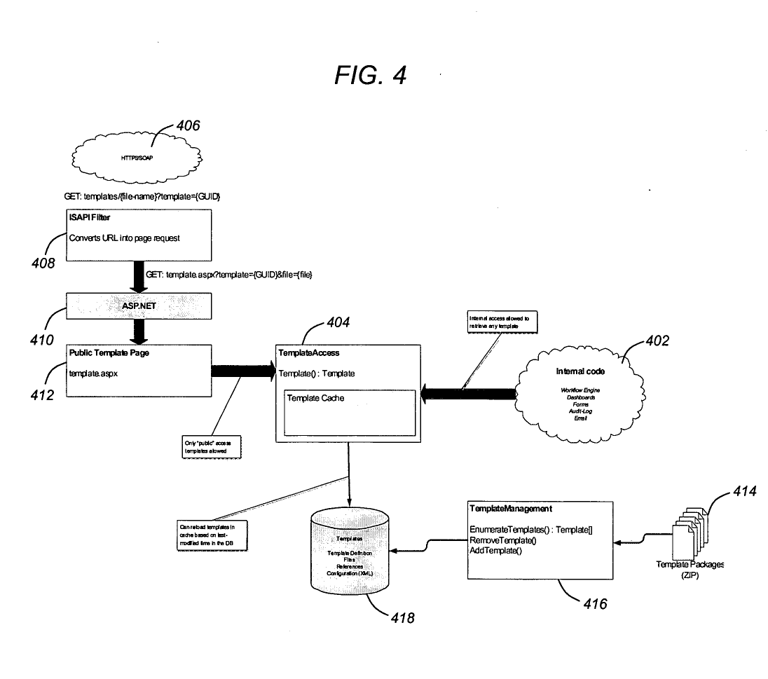

FIG. 4 depicts the interactions of APIs from both an internal and public viewpoint. As can be seen, the internal code 402 may utilize an internal API to access/retrieve any template using the template access class 404. Similarly, HTTP requests 406 may be processed through an ISAPI filter 408 to convert the URL into a page request. The GET page request may then be processed through an application service provider (ASP) 410 (e.g., the ASP.NET protocol) to a public template page 412 that utilizes the template access class 404.

Also illustrated in FIG. 4 is the loading of the template packages 414 by the template management class 416 into the various databases/tables 418 (e.g., as described above. The template access class 404 may then reload templates in cache based on the last modified time in the database 418 established by the template management class 416.

The ASP.NET 410 processing provides capabilities relating to the different aspects of a template. In this regard, the notion of “culture” in .NET is significant in the functionality further described in this document. “Culture” in .NET defines the language and locale (region) of a specific request. The NET CLR framework allows a current culture to be associated with the currently executing thread. With ASP.NET, the incoming “Accept-Language” headers may be translated into a culture when an HTTP request 406 arrives at the server. The flow of control may then simply reference the current culture to determine the language or region-specific representations of data.

Thus, as illustrated in FIG. 4, the public API to access templates may be through a combination of an ISAPI filter 408 and a IHttpHandler class that is serving a specific URL. The functionality is as follows:
1. A client issues a request to access a file (e.g., “logo.gif”) in a particular RFI form template (e.g., an HTTP request 406). The request 406 references and
   URL such as https://work.buzzsaw.com/bz template/logo.gif?id=4BD40ACF-DD12-4ee0-888D-8B52B5CC52C6
2. An ISAPI filter 408 picks up the request and converts the request to an ASPX page reference:
   https://projectpoint.buzzsaw.com/template.aspx?id=4BD40ACF-DD12-4ee0- 888D-8B52B5CC52C6&file=logo.gif
3. An IHttpHandler 412 (that is configured to serve template.aspx) picks up the request and addresses the TemplateAccess API 404 to determine whether the file in that template (by id) is publicly accessible.
4. If the file is publicly accessible, the IHttpHandler retrieves the data stream for the file and streams the data back to the client.

The template manifest (XML) described above is parsed during addition of a template package 414 and it is added to a number of database tables 418 (e.g., through the template management class). Using the APIs described above, the files and configuration may be retrieved using an object-model specific to the data within the templates.

All the configuration specific objects may use the .NET XML Serialization classes so that the properties of the classes specify the XML attributes and element from which their values may be retrieved. This allows the storage of template-specific configuration as XML in the database 418, and at runtime the XML may be parsed and converted into the relevant objects. This allows the configuration fields to be more flexible going forward and shields the application from constant DB Schema changes.

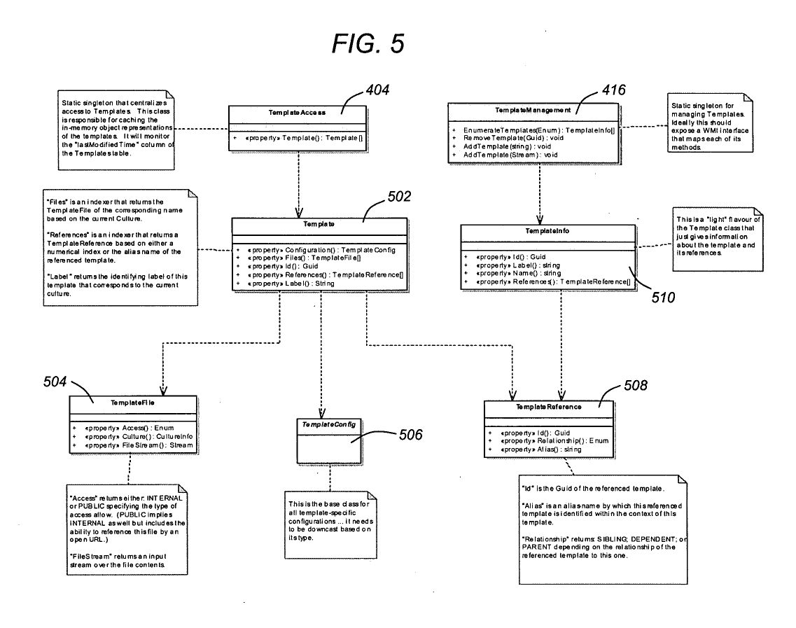

FIG. 5 illustrates a unified modeling language (UML) diagram depicting the object model for access to templates in accordance with one or more embodiments of the invention. The template access class 404 is a static singleton that centralizes access to templates. The template access class 404 is responsible for caching the in-memory object representations of the templates and will monitor the “lastModifiedTime” column of the templates table 300.

The template class 502 provides information about a template or files of a template. In this regard, the “Files” method is an indexer that returns the TemplateFile of the corresponding name based on the current culture. The “References” method is an indexer that returns a TemplateReference based on either a numerical index or the alias name of the referenced template. Further, the “Label” method returns the identifying label of this template that corresponds to the current culture.

The TemplateFile class 504 provides the accessibility of the contents of the a template (e.g., internal or public) and streams out the file contents. The TemplateConfig class 506 is the base class for all template-specific configurations and is downcast based on its type. Thus, below each TemplateConfig class 506 would be a separate UML for each of the different types of templates that provides template-type specific information.

The TemplateReference class 508 provides information relating to the related templates. Accordingly, the ID method returns the GUID of the referenced template, the alias method returns an alias name by which the referenced template is identified within the context of the template, and the relationship method returns the relationship type (e.g., universal, sibling, dependent, parent, etc.).

The TemplateManagement class 416 is a static singleton for managing templates. Accordingly, it may add or remove a template.

The Templatelnfo class 510 is a “light” version of the Template class 502 that just provides information about the template and its references.

Logical Flow

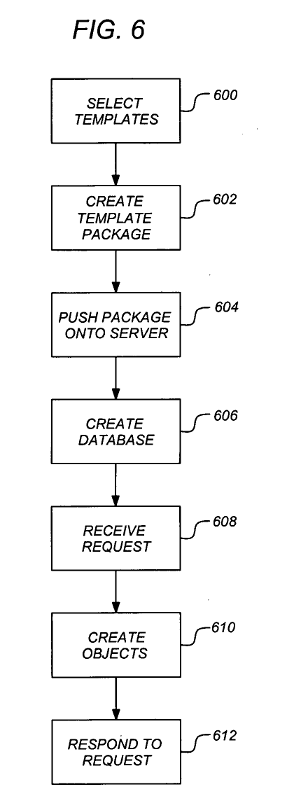

FIG. 6 illustrates the logical flow for creating and using templates in accordance with one or more embodiments of the invention. At step 600, the various templates to be used are selected. Such a selection process may be interactive in real time by the user (e.g., through a graphical user interface, a locally executing software application, or across a network connection such as the Internet). Alternatively, the user may merely specify different functionality or options that are desirable and a service provider may customize or select the various templates. The selected templates likely consist of various XML based files.

Once selected, a template package is created at step 602. As described above, the template package consists of the various templates (e.g., XML manifest files) and all of the additional files needed by the template. Further, the template package likely consists of an application template that includes all of the other templates within it in a compressed or zip format. Thus, the template package consists of one or more files and configuration data for one or more templates that each consist of functionality provided by a server.

At step 604, the template package is pushed/deployed to the server that is hosting the online collaboration services. The server opens the package and transitions/converts the files (from the template package) into a live database. In this regard, a set of tables is created/modified with the information/table data contained in the files. Accordingly, the actual representation of the application lies in the database and not in the application server that is hosting the collaboration services. Further, the application server utilizes the database.

At step 608, a request to utilize a particular service or aspect of the service is received from a client. At step 610, the server dynamically creates one or more objects based on the set of tables. Alternatively, the table data is dynamically and automatically converted into the objects at runtime. In this regard, upon receiving the request, all of the objects for all of the templates/services for the particular user site may be created/instantiated. Alternatively, only those objects needed to respond to the client request may be created/instantiated. Whether all or a portion of the objects are created/instantiated, they are all created automatically and dynamically, without the user's knowledge. The server may then respond to the request by providing the requested feature (e.g., form, user interface, report, etc.) to the client at step 612.

Once the various objects and services have been initialized, any other clients that are part of the collaboration service merely utilize the existing objects. However, a check may be performed whenever a new request is received that confirms that the most recent version of the objects and templates are being used. If an older version is being utilized, new objects may or may not be created depending on the client's desires and/or server settings.

Further, when a client accesses a service or initiates a request, various multicultural/multilingual aspects may be easily utilized since the appropriate file is merely retrieved through the API and database that has been configured based on the templates. Thus, the invention is very pervasive in that all aspects of an online collaboration service are covered through the use of the various templates.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer implemented method for providing a network collaboration service, comprising:
receiving a template package on a server, wherein the template package comprises one or more files and configuration data for one or more templates that each comprise functionality provided by the server for a network collaboration service;
converting the one or more files and configuration data from the template package to table data in a set of one or more tables in a database;
receiving a request from a client for a feature of the network collaboration service;
dynamically converting table data into one or more objects at runtime; and
utilizing the one or more objects to provide the feature to the client.

2. The method of claim 1, wherein the template package is compressed.

3. The method of claim 1, wherein each template in the template package is defined via an extensible markup language (XML) file and all related files for the template.

4. The method of claim 1, wherein one of the templates comprises an application template that identifies a particular application as an aggregation of ancillary templates.

5. The method of claim 1, wherein one of the templates comprises a user interface template that defines hypertext markup language (HTML) pages and application programming interface calls that constitute a surface of a typical application.

6. The method of claim 1, wherein one of the templates comprises a form template that defines a data form used to supply data to the online collaboration service.

7. The method of claim 1, wherein one of the templates comprises an entity template that defines basic data object s and an entire domain data model for the online collaboration service.

8. The method of claim 1, wherein one of the templates comprises a workflow template that describes business logic of the online collaboration service as a scripted workflow.

9. The method of claim 1, wherein one of the templates comprises a dashboard template that defines a report against the online collaboration service.

10. The method of claim 1, wherein one of the templates comprises an email template that defines a layout and contents of an automated email sent to a client as part of the online collaboration service's workflow.

11. The method of claim 1, further comprising:
determining a language based on the request from the client;
wherein the dynamic converting of table data into one or more objects comprises:
retrieving a template name from the set of one or more tables;
retrieving, from the set of one or more tables, feature data for the feature based on the template name and language; and
instantiating the one or more objects based on the feature data.

12. The method of claim 1, wherein the configuration data for one of the templates comprises a manifest file that comprises an identification of one or more additional related templates and a type of a relationship between the template and additional template.

13. The method of claim 1, wherein:
some aspects of the one or more templates are public content; and
some aspects of the one or more templates are only accessible to internal application logic.

14. The method of claim 1, further comprising:
receiving an update to a template; and
dynamically converting the updated template into the set of one or more tables without restarting software on the server.

15. An apparatus for providing a computer network collaboration service comprising:
(a) a server computer having a memory;
(b) a server application executing on the server computer, wherein the server application is configured to:
(i) receive a template package, wherein the template package comprises one or more files and configuration data for one or more templates that each comprise functionality provided by the server computer for a network collaboration service;
(ii) convert the one or more files and configuration data from the template package to table data in a set of one or more tables in a database;
(iii) receive a request from a client for a feature of the network collaboration service;
(iv) dynamically convert table data into one or more objects at runtime; and
(v) utilize the one or more objects to provide the feature to the client.

16. The apparatus of claim 15, wherein the template package is compressed.

17. The apparatus of claim 15, wherein each template in the template package is defined via an extensible markup language (XML) file and all related files for the template.

18. The apparatus of claim 15, wherein one of the templates comprises an application template that identifies a particular application as an aggregation of ancillary templates.

19. The apparatus of claim 15, wherein one of the templates comprises a user interface template that defines hypertext markup language (HTML) pages and application programming interface calls that constitute a surface of a typical application.

20. The apparatus of claim 15, wherein one of the templates comprises a form template that defines a data form used to supply data to the online collaboration service.

21. The apparatus of claim 15, wherein one of the templates comprises an entity template that defines basic data object s and an entire domain data model for the online collaboration service.

22. The apparatus of claim 15, wherein one of the templates comprises a workflow template that describes business logic of the online collaboration service as a scripted workflow.

23. The apparatus of claim 15, wherein one of the templates comprises a dashboard template that defines a report against the online collaboration service.

24. The apparatus of claim 15, wherein one of the templates comprises an email template that defines a layout and contents of an automated email sent to a client as part of the online collaboration service's workflow.

25. The apparatus of claim 15, wherein the server application is further configured to:
determine a language based on the request from the client;
wherein the dynamic converting of table data into one or more objects comprises:
retrieving a template name from the set of one or more tables;
retrieving, from the set of one or more tables, feature data for the feature based on the template name and language; and
instantiating the one or more objects based on the feature data.

26. The apparatus of claim 15, wherein the configuration data for one of the templates comprises a manifest file that comprises an identification of one or more additional related templates and a type of a relationship between the template and additional templates.

27. The apparatus of claim 15, wherein:
some aspects of the one or more templates are public content; and
some aspects of the one or more templates are only accessible to internal application logic.

28. The apparatus of claim 15, wherein the server application is further configured to:
receive an update to a template; and
dynamically convert the updated template into the set of one or more tables without restarting software on the server.

29. An article of manufacture comprising a program storage medium readable by a computer and embodying one or more instructions executable by the computer to perform a method for providing a network collaboration service in a computer system, the method comprising:
receiving a template package on a server, wherein the template package comprises one or more files and configuration data for one or more templates that each comprise functionality provided by the server for a network collaboration service;
converting the one or more files and configuration data from the template package to table data in a set of one or more tables in a database;
receiving a request from a client for a feature of the network collaboration service;
dynamically converting table data into one or more objects at runtime; and
utilizing the one or more objects to provide the feature to the client.

30. The article of manufacture of claim 29, wherein the template package is compressed.

31. The article of manufacture of claim 29, wherein each template in the template package is defined via an extensible markup language (XML) file and all related files for the template.

32. The article of manufacture of claim 29, wherein one of the templates comprises an application template that identifies a particular application as an aggregation of ancillary templates.

33. The article of manufacture of claim 29, wherein one of the templates comprises a user interface template that defines hypertext markup language (HTML) pages and application programming interface calls that constitute a surface of a typical application.

34. The article of manufacture of claim 29, wherein one of the templates comprises a form template that defines a data form used to supply data to the online collaboration service.

35. The article of manufacture of claim 29, wherein one of the templates comprises an entity template that defines basic data object s and an entire domain data model for the online collaboration service.

36. The article of manufacture of claim 29, wherein one of the templates comprises a workflow template that describes business logic of the online collaboration service as a scripted workflow.

37. The article of manufacture of claim 29, wherein one of the templates comprises a dashboard template that defines a report against the online collaboration service.

38. The article of manufacture of claim 29, wherein one of the templates comprises an email template that defines a layout and contents of an automated email sent to a client as part of the online collaboration service's workflow.

39. The article of manufacture of claim 29, wherein the method further comprises:
determining a language based on the request from the client;
wherein the dynamic converting of table data into one or more objects comprises:
retrieving a template name from the set of one or more tables;
retrieving, from the set of one or more tables, feature data for the feature based on the template name and language; and
instantiating the one or more objects based on the feature data.

40. The article of manufacture of claim 29, wherein the configuration data for one of the templates comprises a manifest file that comprises an identification of one or more additional related templates and a type of a relationship between the template and additional template.

41. The article of manufacture of claim 29, wherein:
some aspects of the one or more templates are public content; and
some aspects of the one or more templates are only accessible to internal application logic.

42. The article of manufacture of claim 29, wherein the method further comprises:
receiving an update to a template; and
dynamically converting the updated template into the set of one or more tables without restarting software on the server.
